(19) United States
(12) Patent Application Publication
(10) Pub. No.: US 2017/0234971 A1
(43) Pub. Date: Aug. 17, 2017

(54) PHASE CALIBRATION DEVICE FOR A PLURALITY OF TRANSMISSION ANTENNAS

(71) Applicant: DENSO CORPORATION, Kariya-city (JP)

(72) Inventor: Chihiro ARAI, Kariya-city (JP)

(21) Appl. No.: 15/407,464

(22) Filed: Jan. 17, 2017

(30) Foreign Application Priority Data
Feb. 15, 2016 (JP) 2016-25858

(51) Int. Cl. G01S 7/40; H04L 5/00; H04W 16/28; H04B 17/12

(52) U.S. Cl. CPC G01S 7/4008; H04B 17/12; H04L 5/0048; H04W 16/28

(57) ABSTRACT

In a phase calibration device, a first integrated circuit outputs a transmission signal for generating a transmission wave of a first transmission antenna, a second integrated circuit outputs a transmission signal for generating a transmission wave of a second transmission antenna, a calibration reception antenna is disposed in a state to be theoretically identical in electric coupling amount when receiving the transmission waves of the first transmission antenna and the second transmission antenna, a reception circuit acquires a received signal from the calibration reception antenna, and a control circuit calibrates phases of the transmission signals based on an amplitude of the received signal of the reception circuit when the first integrated circuit and the second integrated circuit output the transmission signals to the first transmission antenna and the second transmission antenna.

### CROSS REFERENCE TO RELATED APPLICATIONS

The present application is based on Japanese Patent Application No. 2016-25858 filed on Feb. 15, 2016, the disclosure of which is incorporated herein by reference.

### TECHNICAL FIELD

The present disclosure relates to a phase calibration device for a plurality of transmission antennas.

### BACKGROUND

In recent years, for example, a millimeter wave radar has been applied to a collision avoidance system that is installed in front of a vehicle for avoiding a collision between the vehicle and a peripheral object. Such a millimeter wave radar uses a plurality of transmission antennas, and changes a phase of transmission waves transmitted from the transmission antennas, thereby being capable of electrically adjusting a signal transmission direction (for example, see JP 2015-152335 A, which corresponds to US 2015/0226838 A1).

To practically configure the above-described device, a plurality of transmission antennas must be implemented. In this case, it is practically preferable to combine a plurality of integrated circuits with the transmission antennas for outputting transmission signals. However, for example, in the configuration combining the integrated circuits together, lengths of lines that connect between the respective integrated circuits may increase to the extent that cannot be ignored with respect to a wavelength of the transmission waves (for example, millimeter wave band). It has been proved that, in such a case, a phase shift of the transmission waves from the transmission antennas to be controlled by the integrated circuits occurs, and a beam forming technology with intended directivity characteristics cannot be achieved. Such an issue occurs likewise in the system equipped with the beam forming technology using a plurality of transmission antennas.

### SUMMARY

It is an object of the present disclosure to provide a phase calibration device for a plurality of transmission antennas which is capable of calibrating a phase of transmission signals from the transmission antennas even when a plurality of integrated circuits corresponding to the transmission antennas is provided.

A phase calibration device according to an aspect of the present disclosure includes a plurality of transmission antennas, a first integrated circuit, a second integrated circuit, a calibration reception antenna, a reception circuit, and a control circuit. The transmission antennas are disposed to enable directions of transmission waves to be changed using a beam forming technology. The transmission antennas include a first transmission antenna and a second transmission antenna that is different from the first transmission antenna. The first integrated circuit outputs a transmission signal for generating the transmission wave of a first transmission antenna using a reference signal upon receiving the reference signal.

The second integrated circuit is connected to the first integrated circuit, receives a reference signal from the first integrated circuit, and outputs a transmission signal for generating the transmission wave of a second transmission antenna. The calibration reception antenna is disposed in a state to be theoretically identical in electric coupling amount when receiving the transmission waves of the first transmission antenna and the second transmission antenna. The reception circuit acquires a reception signal from the calibration reception antenna.

The control circuit calibrates phases of the transmission signals based on an amplitude of the received signal of the reception circuit which is changed in response to a change in a phase difference between the transmission signals when the first integrated circuit and the second integrated circuit output the transmission signals to the first transmission antenna and the second transmission antenna.

The phase calibration device can calibrate phases of transmission signals from a plurality of transmission antennas even when a plurality of integrated circuits corresponding to the transmission antennas is provided.

### BRIEF DESCRIPTION OF THE DRAWINGS

Additional objects and advantages of the present disclosure will be more readily apparent from the following detailed description when taken together with the accompanying drawings. In the drawings:

FIG. 1 is a diagram schematically illustrating an electric configuration of a millimeter wave radar system according to a first embodiment;

FIG. 2 is a perspective view schematically illustrating a partial configuration of transmission antennas and a cross-section of a substrate;

FIG. 3 is a flowchart schematically illustrating a calibration procedure;

FIG. 4 is a characteristic diagram illustrating a reception amplitude to a phase change;

FIG. 5 is a flowchart schematically illustrating a calibration procedure according to a second embodiment;

FIG. 6 is a characteristic diagram illustrating a reception amplitude to a phase change;

FIG. 7 is a characteristic diagram illustrating a reception amplitude to a phase change;

FIG. 8 is a flowchart schematically illustrating a calibration procedure according to a third embodiment;

FIG. 9 is a characteristic diagram illustrating a reception amplitude to a phase change;

FIG. 10 is a characteristic diagram illustrating a reception amplitude to a phase change;

FIG. 11 is a diagram schematically illustrating an electric configuration of a millimeter wave radar system according to a fourth embodiment;

FIG. 12 is a diagram schematically illustrating an electric configuration of a millimeter wave radar system according to a fifth embodiment;

FIG. 13 is a top view illustrating an enlarged reception antenna;

FIG. 14 is a diagram schematically illustrating an electric configuration of a millimeter wave radar system according to a sixth embodiment;

FIG. 15 is a diagram schematically illustrating an electric configuration of a millimeter wave radar system according to a seventh embodiment;

FIG. 16 is a diagram schematically illustrating an electric configuration of a millimeter wave radar system according to an eighth embodiment;

FIG. 17 is an enlarged top view illustrating a part of transmission antennas and a reception antenna; and

FIG. 18 is a diagram schematically illustrating an electric configuration of a millimeter wave radar system according to a ninth embodiment.

### DETAILED DESCRIPTION

Hereinafter, several embodiments of a phase calibration device for a plurality of transmission antennas will be described with reference to the accompanying drawings. In the respective embodiments described below, configurations that perform the same or similar operation are denoted by the same or similar reference numerals, and their description will be omitted as necessary. In the following embodiments, the same or similar configurations are denoted by the same reference numerals with tens place and ones place for description. Hereinafter, the phase calibration device applied to a millimeter wave radar system using a beam forming technology will be described.

### First Embodiment

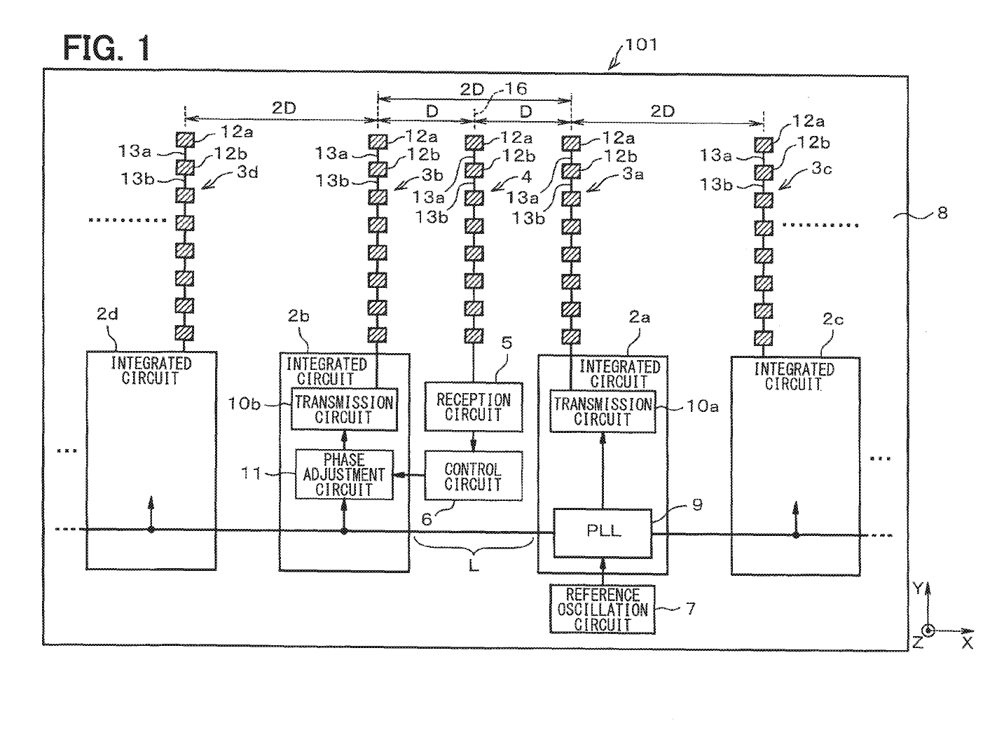

FIGS. 1 to 4 illustrate illustrative views of a first embodiment. FIG. 1 schematically illustrates an electric configuration. A millimeter wave radar system 101 is configured in such a manner that a plurality of integrated circuits 2a, 2b, 3c, 2d . . . , a plurality of transmission antennas 3a, 3b, 3c, 3d . . . , a calibration reception antenna 4, a reception circuit 5, a control circuit 6, and a reference oscillation circuit 7 are mounted on, for example, a single substrate 8. One integrated circuit 2a performs master operation, the other integrated circuits 2b, 2c, 2d . . . perform slave operation, and the integrated circuits 2a, 2b . . . have a radar signal transmission function for the respective transmission antennas 3a, 3b . . . . The integrated circuit 2a corresponds to a first integrated circuit. The integrated circuits 2b . . . correspond to a second integrated circuit. The transmission antenna 3a corresponds to a first transmission antenna. The transmission antennas 3b . . . correspond to a second transmission antenna.

Four of the integrated circuits 2a, 2b, 2c, 2d . . . are illustrated in FIG. 1, but the number of integrated circuits may be set to two or three, or five or more. Because configurations of the integrated circuits 2b, 2c, 2d . . . that perform the slave operation are identical with each other, a relationship between the integrated circuit 2a that performs the master operation and the integrated circuit 2b that performs the slave operation will be described below. The configurations and cooperative operation of the integrated circuits 2c, 2d . . . with the integrated circuit 2a will be described, but the same operation as that in a relationship between the integrated circuits 2a and 2b will be omitted from the description.

One integrated circuit 2a that performs the master operation includes a phase locked loop (PLL) circuit 9 and a transmission circuit 10a. The integrated circuit 2b that performs the slave operation includes a phase adjustment circuit 11 and a transmission circuit 10b. The calibration reception antenna 4 is connected with the reception circuit 5, and the reception circuit 5 is connected with the control circuit 6. The control circuit 6 controls a calibration phase φ of the phase adjustment circuit 11. The control circuit 6 is formed on the substrate 8 separately from the integrated circuits 2a and 2b, and configured by, for example, a microcomputer incorporating a memory using a dedicated integrated circuit.

In addition, the reference oscillation circuit 7 is formed outside of the integrated circuits 2a, 2b . . . . The reference oscillation circuit 7 generates an oscillation signal of a given reference frequency, and outputs the oscillation signal to the PLL circuit 9 inside of the integrated circuit 2a. Upon receiving the oscillation signal from the reference oscillation circuit 7, the PLL circuit 9 in the integrated circuit 2a multiplies the oscillation signal to generate a reference signal high in precision. With the above configuration, the PLL circuit 9 can generate the high-precision reference signal having a predetermined frequency. The reference signal of the PLL circuit 9 is output to the transmission circuit 10a inside of the integrated circuit 2a that performs the master operation as well as the phase adjustment circuit 11 inside of the integrated circuit 2b that performs the slave operation. Upon receiving the reference signal from the integrated circuit 2a, the integrated circuit 2b adjusts a phase of the reference signal by the phase adjustment circuit 11, and outputs the adjusted reference signal to the transmission circuit 10b.

The transmission circuits 10a and 10b in the integrated circuits 2a and 2b generate transmission signals from the transmission antennas 3a and 3b connected to the integrated circuits 2a and 2b using the reference signals input to the transmission circuits 10a and 10b, respectively, and output the generated transmission signals to the transmission antennas 3a and 3b at the same time. Feeding points of the integrated circuits 2a and 2b are connected with transmission antennas 3a and 3b, respectively.

As illustrated in FIG. 1, it is assumed that one direction of a planar direction of a front layer L1 of the substrate 8 is an X-direction, another direction of the planar direction of the front layer L1 which intersects with the X-direction is a Y-direction, a depth direction of the substrate 8 which intersects with both of the X-direction and the Y-direction is a Z-direction. In particular, a relationship between the transmission antenna 3a and the calibration reception antenna 4 will be described mainly focused on a relationship in an XY-plane.

The transmission antennas 3a, 3b . . . are configured as array antennas extended in the same Y-direction and spaced apart from each other in the X-direction. With the array of the transmission antennas 3a, 3b . . . described above, the direction of the transmission waves can be changed using the beam forming technology. The transmission antennas 3a, 3b . . . are identical in shape with each other. With the configuration in which a larger number of transmission antennas 3a, 3b . . . are arrayed in parallel, a precision and a gain of the beam forming can be enhanced.

The transmission antennas 3a, 3b . . . are spaced apart from each other by a distance 2D in the X-direction. The distance 2D is a distance as long as the distance 2D cannot be ignored with respect to a wavelength (a few mm) corresponding to a frequency output by the PLL circuit 9. The calibration reception antenna 4 is disposed between, for example, two transmission antennas 3a and 3b located on a center side of the substrate 8 among the transmission antennas 3a, 3b . . . . FIG. 1 illustrates the calibration reception antenna 4 for showing the features of the present embodiment. Alternatively, target detection reception antennas may be disposed separately, or the target detection reception antennas may also work as the calibration reception antenna.

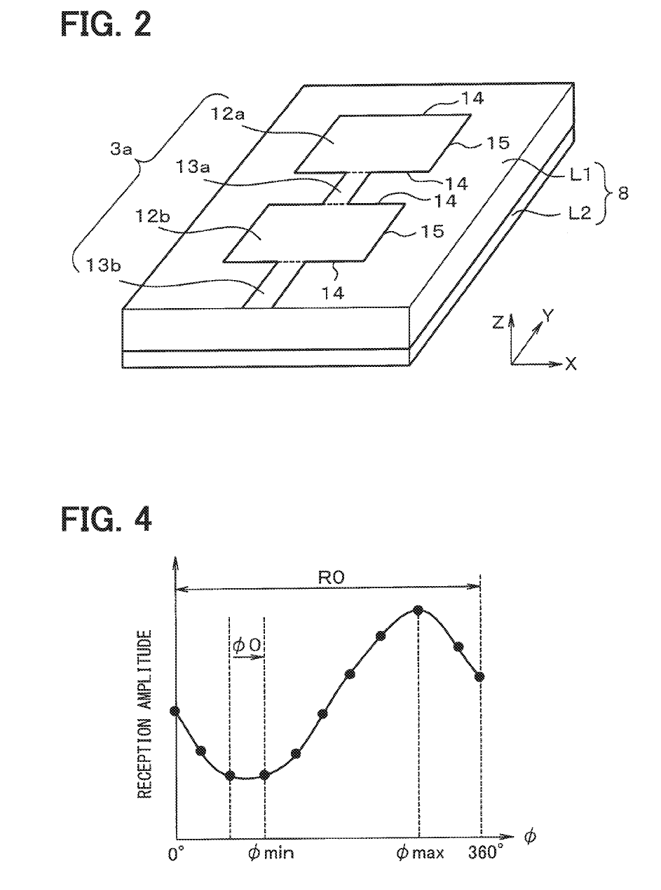

The calibration reception antenna 4 is disposed at a position and an area where distances D from two transmission antennas 3a and 3b adjacent to both sides of the calibration reception antenna 4 in the X-direction are equal to each other. In particular, at least a part of the calibration reception antenna 4 is disposed in a bisector 16 between the two adjacent transmission antennas 3a and 3b. In the present embodiment, the calibration reception antenna 4 has the same structure as a pattern structure of the respective transmission antennas 3a, 3b . . . . Thus, the pattern structure of one transmission antenna 3a will be described with reference to FIG. 2, and the pattern structures of the other transmission antennas 3b . . . and the calibration reception antenna 4 will be omitted from the description.

FIG. 2 illustrates a partial planar configuration of the transmission antenna 3a together with a cross-section of a front layer side of the substrate 8. The substrate 8 is configured by a multilayer substrate, and a pattern of the transmission antenna 3a is formed on the front layer L1 of the substrate 8. A second layer L2 from the front layer L1 of the substrate 8 is formed as a solid ground surface. A third layer and subsequent layers from the front layer L1 of the substrate 8 are omitted from the illustration. The patterns of the transmission antennas 3b . . . are formed on the front layer L1 of the substrate 8, but are not illustrated in FIG. 2. In addition, the integrated circuits 2a, 2b . . . and the various circuits 5 to 7 are mounted on the substrate 8, but are not illustrated in FIG. 2. The transmission antenna 3a is configured in such a manner that patch antennas 12a and 12b are coupled with each other through one or a plurality of microstriplines 13a and 13b. In FIG. 1, metal surfaces of the front layer L1 of the patch antennas 12a and 12b are hatched.

Each of the patch antennas 12a and 12b illustrated in FIG. 2 includes a rectangular metal surface on the front layer L1 of the substrate 8, and one side 14 of the rectangular metal surface is extended in the X-direction, and the other side 15 is extended along the Y-direction. Both of the sides 14 and 15, for example, orthogonally cross each other. The transmission antenna 3a is configured in such a manner that the centers of the sides 14 of the metal surfaces of the patch antennas 12a and 12b are coupled with each other through the microstriplines 13a and 13b. The lengths of portions of the microstriplines 13a and 13b which couple the patch antennas 12a, 12b . . . to the transmission circuits 10a, 10b . . . of the integrated circuits 2a, 2b . . . are identical among the respective transmission antennas 3a, 3b . . . . In other words, a total line length of the microstriplines 13a and 13b . . . of the respective transmission antennas 3a, 3b . . . connected to the transmission circuits 10a, 10b . . . is identical among the transmission antennas 3a, 3b . . . .

On the other hand, the microstriplines 13a and 13b that couple the patch antennas 12a and 12b of the reception antenna 4 with each other are disposed, for example, so that a center of the microstriplines 13a and 13b in the X-direction is located on a bisector 16 between the transmission antennas 3a and 3b.

The reception antenna 4 is disposed in a facing area of the transmission antennas 3a and 3b in the X-direction, and in the present embodiment, the patch antennas 12a and 12b of the reception antenna 4 are disposed symmetrically in the X-direction with the bisector 16 as a center line. When the reception antenna 4 is disposed in the facing area of the transmission antennas 3a and 3b, the reception antenna 4 can receive the transmission wave directly from the transmission antennas 3a and 3b.

Thus, the calibration reception antenna 4 is disposed in a state to be theoretically identical in electric coupling amount between the transmission antennas 3a and 3b when receiving the transmission waves of the transmission antennas 3a and 3b. All of the transmission antennas 3a, 3b . . . output the transmission waves corresponding to the transmission signal at the same time when receiving the transmission signal. As a result, the transmission waves of all the transmission antennas 3a, 3b . . . become radio waves obtained by combining radio waves output from the transmission antennas 3a, 3b . . . together. In this situation, each of the integrated circuits 2b . . . adjusts and outputs the phase of the transmission signal, thereby being capable of radiating the transmission wave in a state where the direction of the transmission wave is adjusted using the beam forming technology. As a result, the integrated circuits 2b . . . can electrically adjust a signal transmission direction.

Hereinafter, a calibration procedure of the phase of the reference signal through the phase adjustment circuit will be described. First, a significance of the calibration will be described. A phase error of the transmission signals based on internal line lengths of the integrated circuits 2a and 2b and internal circuits of the integrated circuits 2a and 2b is predetermined by the internal configuration at a stage of manufacturing the integrated circuits 2a and 2b. Thus, the internal configuration can be designed and adjusted, and can be easily associated with a phase difference between the reference signal input and the transmission signal output by the integrated circuits 2a and 2b. The integrated circuits 2a and 2b store information on the phase error in an internal memory (not illustrated) in advance, or communicate the information on the phase error with each other, thereby being capable of adjusting the phase error in offset.

However, routes from an output portion of the reference signal in the PLL circuit 9 to the patch antennas 12a on end portions of the transmission antennas 3a and 3b cannot be grasped without mounting the integrated circuits 2a, 2b . . . and the transmission antennas 3a, 3b . . . on the substrate 8. The routes are different for each of the integrated circuits 2a, 2b . . . and the transmission antennas 3a, 3b . . . connected to the integrated circuits, and the phase difference is unknown.

In the present embodiment, when the integrated circuits 2a, 2b . . . are mounted on the substrate 8, a line length L for allowing the signal to propagate on the substrate 8 is present between the integrated circuit 2a equipped with the PLL circuit 9 and the other integrated circuits 2b . . . , as illustrated in FIG. 1. Thus, a phase shift occurs in the reference signal mainly due to the line length L between the integrated circuit 2a and the other integrated circuit 2b. In order to eliminate the phase shift, the phase adjustment circuit 11 is disposed in the integrated circuit 2b, and an initial calibration phase φ by the phase adjustment circuit 11 is determined at a stage before adjusting the phase between the respective transmission antennas 3a, 3b . . . using the beam forming technology. This process is a calibration process. After determining the calibration phase φ, the system 101 shifts the phase of the transmission signal and transmits the transmission signal, thereby making it easy to realize the normal beam forming technology.

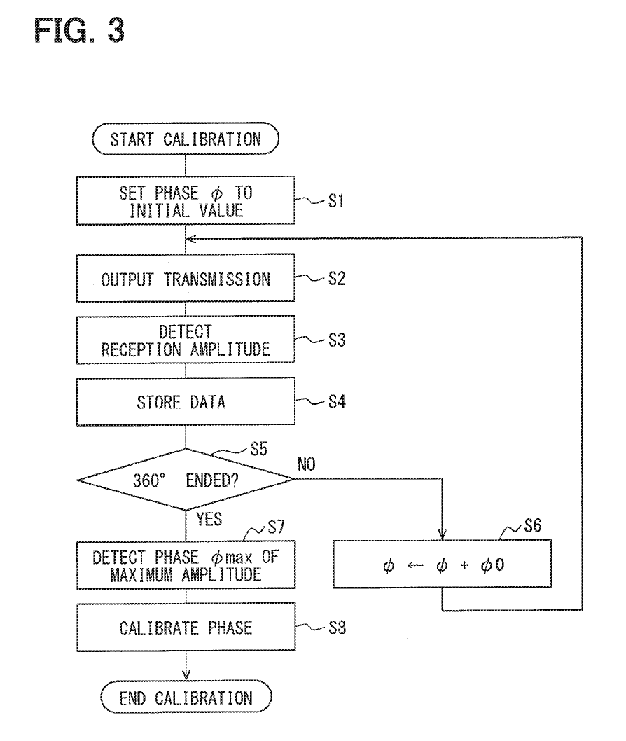

When performing the calibration process, the control circuit 6 adjusts the calibration phase φ of the reference signal by the phase adjustment circuit 11 in the integrated circuit 2b. In this situation, for example, it is desirable to control and calibrate the phase, for example, in a procedure illustrated in FIG. 3. First, in S1, the control circuit 6 sets the calibration phase φ to an initial value (for example, 0°) through the phase adjustment circuit 11. Then, in S2, the transmission circuits 10a, 10b . . . of the respective integrated circuits 2a and 2b output the transmission signals to the transmission antennas 3a, 3b . . . at the same time.

In this situation, it is desirable that the respective transmission circuits 10a, 10b . . . output the transmission signals modulated by a predetermined modulation system to the respective transmission antennas 3a, 3b . . . . As the predetermined modulation system, it is desirable to use, for example, an FMCW (frequency modulated continuous wave) system. The FMCW system is a system in which the transmission signal is transmitted while the frequency of the transmission signal is increased and decreased linearly with respect to a time. Using such a modulation system, the frequency can be changed between the signal of the transmission wave and a signal reflected from a peripheral object of the transmission antennas 3a, 3b . . . , and the frequency of the transmission wave can be easily separated from the frequency of the received signal, and the calibration can be performed with higher precision.

When the transmission circuits 10a, 10b . . . output the transmission signals to the transmission antennas 3a, 3b . . . , the transmission antennas 3a, 3b . . . output the transmission waves. The radiated transmission wave reaches the reception antenna 4, and the reception circuit 5 acquires the signal through the reception antenna 4. In S3, the reception circuit 5 detects an amplitude of the received signal. In S4, the control circuit 6 retains an amplitude value of the received signal acquired by the reception circuit 5 in association with the phase φ in an internal memory. In S6, the control circuit 6, the transmission circuits 10a, 10b . . . , and the reception circuit 5 change the phase φ for each predetermined step φ0 (for example, 1°), and the phase φ reaches 360°. In other words, the processes from S2 to S4 are repeated until the condition in S5 is satisfied.

The control circuit 6, the transmission circuits 10a, 10b . . . , and the reception circuit 5 repeat the processes in S2 to S4. If it is determined that the condition in S5 is satisfied, the control circuit 6, the transmission circuits 10a, 10b . . . , and the reception circuit 5 detect and specify a phase φmax satisfying a condition in which the reception amplitude becomes maximum in S7. In S8, the control circuit 6, the transmission circuits 10a, 10b . . . , and the reception circuit 5 set the phase φmax as the calibration phase φ of the phase adjustment circuit 11, thereby being capable of calibrating the phase.

FIG. 4 illustrates the reception amplitude with which the reception circuit 5 receives the signal through the reception antenna 4 in correspondence with a change in the phase φ. Because the control circuit 6, the transmission circuits 10a, 10b . . . , and the reception circuit 5 repeat the processes in S2 to S4 of FIG. 3 until the condition in S5 is satisfied, as illustrated in FIG. 4, the reception amplitude is held in an internal memory of the control circuit 6 in an range R0 of the phase φ from 0° to 360° for each step φ0. When the phase φ is changed from 0° to 360°, the reception amplitude is gradually changed, and a phase φmin in which the reception amplitude becomes a minimum value and a phase φmax in which the reception amplitude becomes a maximum value are present. In this situation, the reception amplitude is changed into a sine wave with respect to a change in the calibration phase φ.

For simplification of the description, a change in the reception amplitude when the transmission waves are transmitted from the two transmission antennas 3a and 3b toward the reception antenna 4 will be described in principle. For example, when the transmission antennas 3a and 3b output the transmission waves, if the phases of the two transmission waves match each other, because the distances from the transmission antennas 3a and 3b to the reception antenna 4 are equal to each other, the received signals receiving the two transmission waves intensify each other, and signals having a relatively large amplitude are received in the reception antenna 4. Conversely, when the phases of the two transmission signals from the transmission circuits 10a and 10b are opposite to each other, because the transmission signals weaken each other when the reception antenna 4 receives the signals, the amplitude of the signals received by the reception circuit 5 becomes relatively small. When the phase is shifted by 180°, the signal becomes 0 in principle.

In S7 of FIG. 3, the control circuit 6 detects and specifies the phase φ that becomes the highest reception amplitude among the reception amplitudes retained in the internal memory as a maximum phase φmax. In this situation, because a magnitude of the signal interfering with the reception antenna 4 has a correlation with the phase shift, the control circuit 6 detects and specifies the phase in which the amount of interference is maximum, thereby being capable of calibrating the phase.

As illustrated in FIG. 4, the phase φmax that satisfies the condition in which the reception amplitude becomes maximum is a phase in which the phase difference of the transmission waves can be minimized. In S8, the phase φmax is set as the calibration phase φ of the phase adjustment circuit 11 whereby the calibration can be performed so that the reception amplitude is maximized. In this situation, because the calibration process is performed taking an influence of the patch antenna 12a on end portions of the transmission antennas 3a, 3b . . . into account, the phase error corresponding to the line length L between the respective integrated circuits 2a, 2b . . . can be canceled regardless of with what relationship the respective integrated circuits 2a, 2b . . . are disposed on the substrate 8.

After having performed the above calibration process, the integrated circuits 2a, 2b . . . output radar transmission signals in cooperation with each other, to thereby radiate radar transmission waves from the transmission antennas 3a, 3b . . . . In this situation, the radar transmission wave is reflected on a target such as a preceding vehicle or a roadside object, and the reflected radio wave is input to the reception circuit (for example, reception circuit 5) through the reception antenna (for example, reception antenna 4) with a time lag of distances 2R for reciprocation when a distance between a radar and the target is R. The reception circuit (for example, reception circuit 5) mixes the received signal with the transmission signals from the transmission circuits (for example, transmission circuits 10a, 10b, and so on), thereby being capable of acquiring a signal proportional to the distance R. Thus, the distance R between the millimeter wave radar system 101 and the target can be calculated.

As described above, according to the present embodiment, the control circuit 6 calibrates the phase of the transmission signals based on the amplitude of the received signal of the reception circuit 5 which is changed according to a change in the phase difference of the respective transmission signals when the integrated circuits 2a, 2b . . . output the transmission signals to the transmission antennas 3a, 3b . . . . Thus, even when the integrated circuits 2a, 2b . . . are mounted in correspondence with the transmission antennas 3a, 3b . . . , the phase error of the transmission signals output from the respective transmission antennas 3a, 3b . . . corresponding to the integrated circuits 2a, 2b . . . can be detected and determined as the calibration phase φ. With the above configuration, the problem with the conventional art that the phase error of the transmission signals of the respective integrated circuits 2a, 2b . . . cannot be recognized by the respective integrated circuits 2a, 2b . . . can be solved.

In addition, by performing the calibration process according to the present embodiment, the number of transmission antennas 3a, 3b . . . configuring the millimeter wave radar system 101 can be increased without being limited to an area of the substrate 8, the number of mounted components and the number of channels of the transmission circuits 10a, 10b . . . integrated inside of the integrated circuits 2a, 2b . . . .

Because the calibration reception antenna 4 is disposed at an equal distance from the transmission antennas 3a, 3b . . . , the reception antenna 4 can make the phases of the transmission waves from the transmission antennas 3a, 3b . . . identical with each other, detects the phase difference between the transmission antennas, and can use the detected phase difference as an adjustment phase of the phase adjustment circuit 11 as it is.

Because the calibration reception antenna 4 is disposed in the facing area between the transmission antennas 3a, 3b . . . , the reception antenna 4 can receive the transmission waves directly from the transmission antennas 3a, 3b . . . , and can increase the reception amplitude.

The transmission antennas 3a, 3b . . . are configured in such a manner that the patch antennas 12a, 12b . . . are connected to each other by the microstriplines 13a and 13b . . . . Thus, the transmission waves can be output from the individual patch antennas 12a, 12b . . . , and an antenna configuration suitable to the millimeter wave radar system 101 can be obtained.

Because the reception antenna 4 includes a large number of patch antennas 12a, 12b . . . as compared with reception antennas 204 and 304 of an embodiment to be described later, the phase φmax that can obtain an antenna gain, can increase the reception amplitude, and satisfies the condition for the maximum amplitude is easily detected.

### Second Embodiment

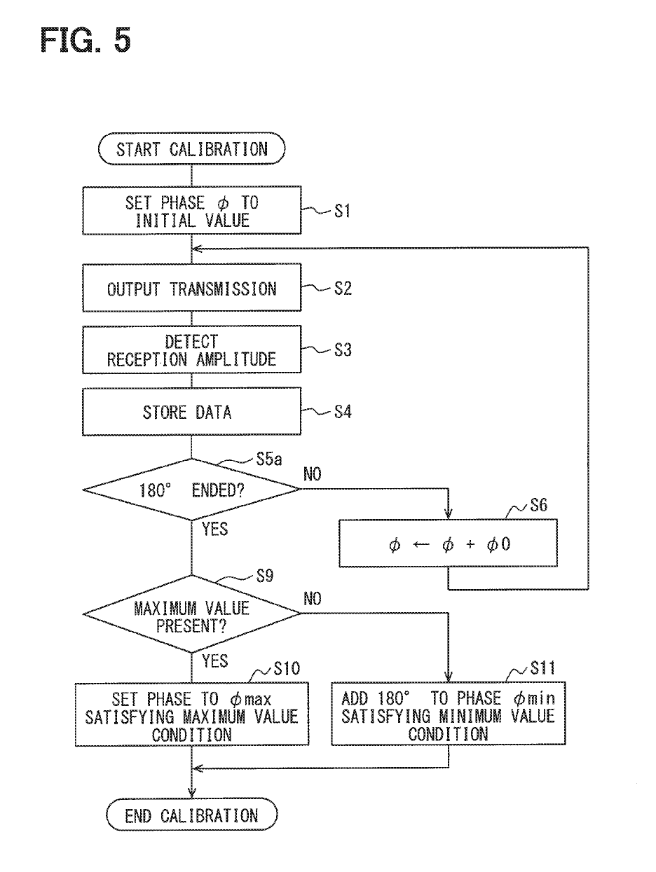

FIGS. 5 to 7 illustrate additional illustrative views of a second embodiment. The second embodiment shows an example in which the calibration procedure is changed. The same or similar reference signs are assigned to the same or similar configuration elements in the foregoing embodiment, and descriptions thereof will be omitted.

As illustrated in FIG. 5, a control circuit 6, transmission circuits 10a, 10b . . . , and a reception circuit 5 perform processes in S1 to S5a and S6. In this example, the control circuit 6 sets a phase φ to an initial value (for example, 0°), adds the phase φ by a predetermined step φ0 in S6 until the phase φ reaches 180° in S5a, and repeats the processes in S2 to S4. The control circuit 6 determines whether a maximum value of a reception amplitude falls within a range R1 satisfying 0°≦R1≦180 in S9. As a method of determining whether the maximum value is present, it may be determined whether the phase of a reception amplitude A2 that satisfies a relationship of A1<A2>A3 is present, when it is assumed that three continuous reception amplitudes are A1, A2, and A3 where the calibration phase φ is the step φ0. The present disclosure is not limited to the above method.

When it is determined that a maximum value of the reception amplitude is present in S9, the control circuit 6 sets a phase φmax satisfying a maximum value condition as a calibration phase φ of the phase adjustment circuit 11 in S10. Conversely, when it is determined that the maximum value of the reception amplitude is not present in the range R1 in S9, the control circuit 6 sets a phase φmin satisfying a minimum value condition as a calibration phase φ of the phase adjustment circuit 11 in S11. As a method of specifying the phase φ satisfying the minimum value condition, the phase φ of a reception amplitude A2 that satisfies a relationship of A1>A2<A3 may be used when it is assumed that three continuous reception amplitudes are A1, A2, and A3 in the phase φ. The present disclosure is not limited to the above method. The present disclosure is not limited to the above method.

Because the phase φmax that satisfies the maximum value condition or the phase φmin that satisfies the minimum value condition are always present in a range R1 of the phase from 0° to 180° in S10 and S11, the phase φmin that satisfies the minimum value condition is always present unless the phase φmax that satisfies the maximum value condition is present in the range R1 in S10. Thus, when the condition in S9 is not satisfied, it is preferable to specify the phase φmin that satisfies the minimum value condition in S11.

The control circuit 6 adds 180° to the phase min that satisfies the minimum value condition, and sets the φmin+180° as the calibration phase φ of the phase adjustment circuit 11. In the above method, in the reception amplitude detected by the reception circuit 5 and the characteristic of the phase adjustment value, one maximum value is always present, and the reception amplitude becomes the minimum value in the phase φ obtained by reversing the phase φmax that satisfies the maximum value condition by 180°, and the reverse of the above case is also established.

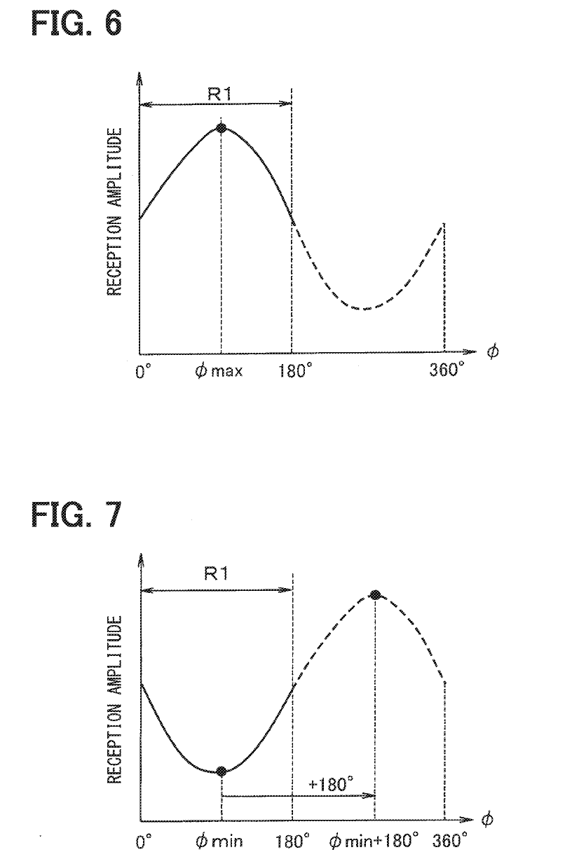

FIGS. 6 and 7 illustrate two examples in which a level of the reception amplitude is compatible with a change in the phase φ. In a flow of a flowchart in FIG. 5, when the control circuit 6 acquires a value of the reception amplitude, as illustrated in FIGS. 6 and 7, the reception amplitude is retained in an internal memory in the control circuit 6 for each step φ in the range R1 of the phase φ from 0° to 180°. As illustrated in FIGS. 6 and 7, in the case where the phase φmax that satisfies the maximum value condition of the reception amplitude is present when the phase φ is changed from 0° to 180°, the phase min that satisfies the minimum value condition of the reception amplitude may be present.

When it is determined that the phase φmax that satisfies the maximum value condition in the reception amplitude retained in the internal memory is present in S9, the control circuit 6 sets the phase φmax as the calibration phase φ of the phase adjustment circuit 11 as illustrated in FIG. 6. When it is determined that the phase φmax that satisfies the maximum value condition in the reception amplitude retained in the internal memory is not present in S9, the control circuit 6 sets φmax+180° obtained by adding 180° to the phase min that satisfies the minimum value condition as the calibration phase φ of the phase adjustment circuit 11 as illustrated in FIG. 7.

The control circuit 6 sets phase φmax and φmin+180° as the calibration phase φ) of the phase adjustment circuit 11, thereby being capable of calibrating the reception amplitude to be maximized. As a result, because the phase φ is swept by 180° to calibrate the phase, a sweep time can be halved as compared with the first embodiment in which the phase φ is swept by 360°. In addition, the same advantages as the in the first embodiment can be obtained.

### Third Embodiment

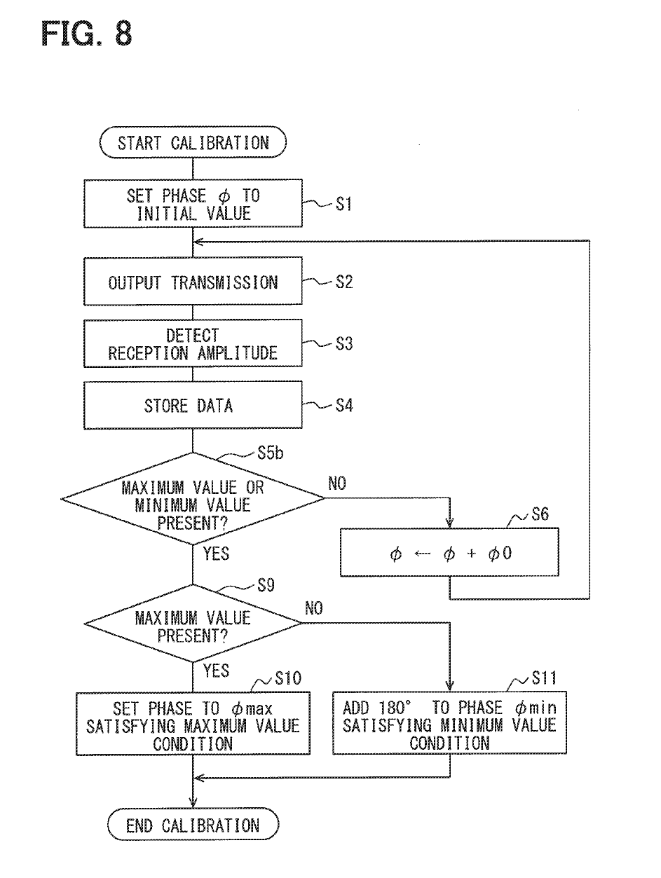

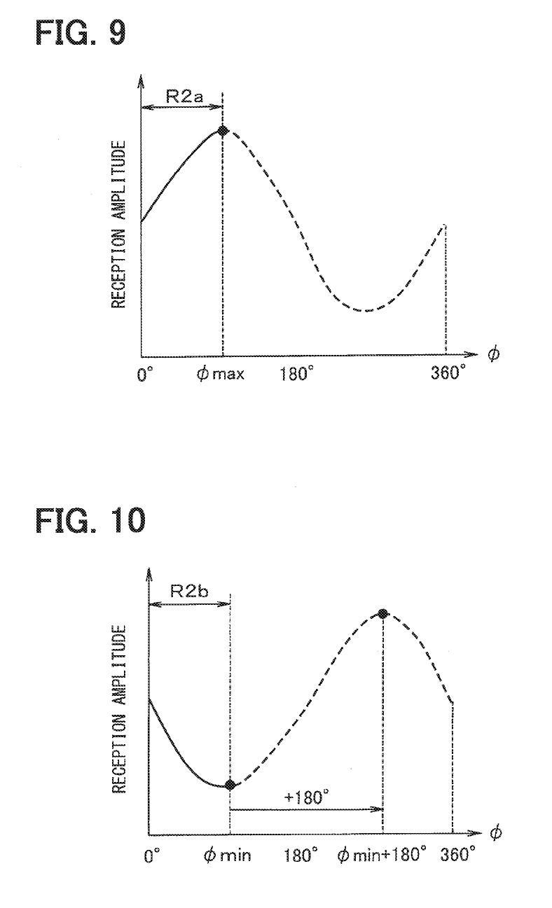

FIGS. 8 and 9 illustrate additional illustrative views of a third embodiment. The third embodiment shows an example in which the calibration procedure is changed. The same or similar reference signs are assigned to the same or similar configuration elements in the foregoing embodiment, and descriptions thereof will be omitted.

As illustrated in FIG. 8, a control circuit 6, transmission circuits 10a, 10b . . . , and a reception circuit 5 perform processes in S1 to S5 and S6. In this example, the control circuit 6 repeats the processes in S2 to S4 until a reception amplitude satisfies a maximum value condition or a minimum value condition in S5b.

As described in the second embodiment, as a method of determining whether the maximum value condition is present, it may be determined whether a reception amplitude A2 that satisfies a relationship of A1<A2>A3 is present, when it is assumed that three continuous reception amplitudes are A1, A2, and A3 in the phase φ. As a method of determining whether the minimum value condition is present, it may be determined whether a reception amplitude A2 that satisfies a relationship of A1>A2<A3 is present, when it is assumed that three continuous reception amplitudes are A1, A2, and A3 in the phase φ. Thereafter, the control circuit 6 performs processes in S9 to S11. The processing contents are the same as the in the second embodiment, and therefore will be omitted from the description.

FIGS. 9 and 10 illustrate two examples in which a level of the reception amplitude is compatible with a change in the phase φ. As illustrated in FIGS. 9 and 10, when it is determined that the phase φmax that satisfies the maximum value condition is present in S5b and S9 in a process where the phase φ is increased from 0°, as illustrated in FIG. 9, the control circuit 6 sets the phase φmax as the calibration phase φ of the phase adjustment circuit 11. When it is determined that the phase φmax that satisfies the maximum value condition is not present in S5b and S9, the control circuit 6 sets φmin+180° obtained by adding 180° to the phase φmin that satisfies the minimum value condition as the calibration phase φ of the phase adjustment circuit 11 as illustrated in FIG. 10. The control circuit 6 sets the phase φmax and φmin+180° thus calculated as the calibration phase φ of the phase adjustment circuit 11, thereby being capable of calibrating the reception amplitude to be maximized.

With the above configuration, the control circuit 6 sweeps the phase φ and stops the sweep at the time when the reception amplitude satisfies the maximum value condition or the minimum value condition so as to calibrate the phase. The control circuit 6 can set a sweep a sweep range to a range R2a illustrated in FIG. 9 or a range R2b illustrated in FIG. 10, and can further reduce the sweep time as compared with a configuration in which the phase φ is swept by 360° or 180°. In addition, the same advantages as the in the first embodiment can be obtained.

### Fourth Embodiment

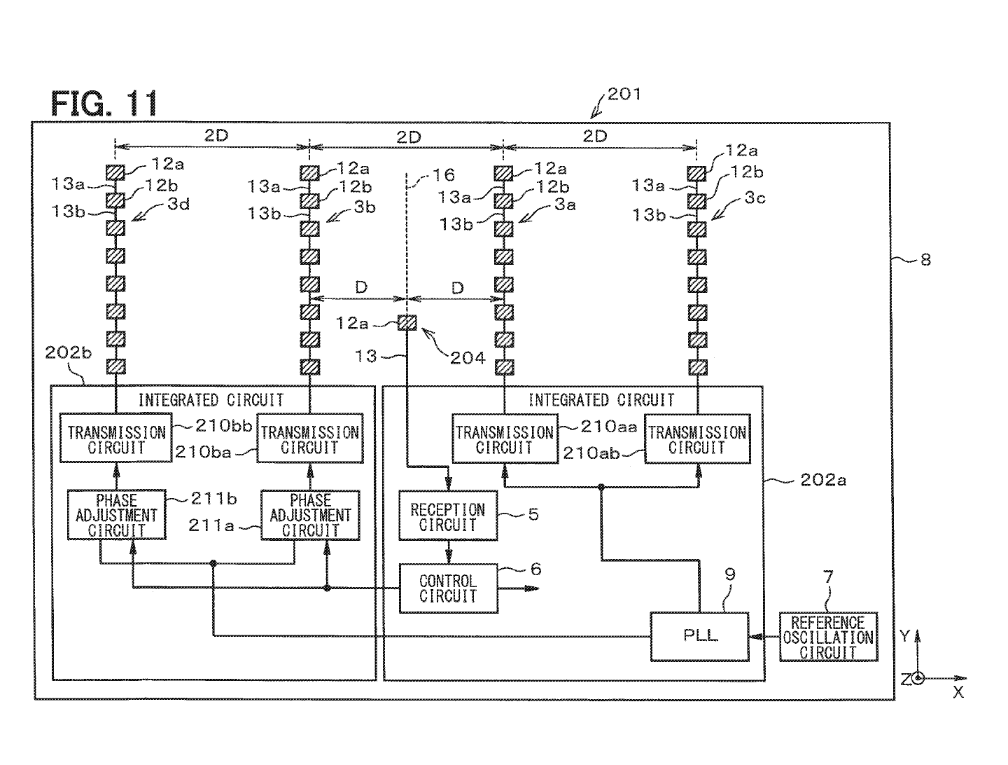

FIG. 11 illustrates an additional illustrative view of a fourth embodiment. The fourth embodiment illustrates another configuration of a reception antenna. The fourth embodiment illustrates a configuration in which one integrated circuit outputs transmission signals of transmission antennas.

A millimeter wave radar system 201 includes integrated circuits 202a, 202b, transmission antennas 3a, 3b . . . , and a reference oscillation circuit 7. The integrated circuit 202a that performs master operation includes plural transmission circuits 210aa and 210ab of the same number (for example, 2) as that of the channels, and output the transmission signals to the transmission antennas 3a and 3c connected to the respective transmission circuits 210aa and 210ab for the channels. The integrated circuit 202a includes a PLL circuit 9, a reception circuit 5, and a control circuit 6 described in the first embodiment.

As illustrated in the present embodiment, the reception circuit 5 and the control circuit 6 may be integrated within the integrated circuit 202a without being separated from the integrated circuit 202a on the substrate 8. The PLL circuit 9, the reception circuit 5, and the control circuit 6 perform the same control as that described in the above embodiments, and their operation will be omitted from the description.

The integrated circuit 202b that performs the slave operation is equipped with transmission circuits 210ba, 210bb, and phase adjustment circuits 211a, 211b for channels. Upon receiving a calibration phase φ from the control circuit 6, the phase adjustment circuits 211a and 211b calibrate a phase of a reference signal output by the PLL circuit 9 according to the received calibration phase φ, and output the calibrated reference signal to respective transmission circuits 210ba and 210bb. The transmission circuits 210ba and 210bb of the integrated circuit 202b generate the transmission signals for generating the transmission waves of the transmission antennas 3b and 3d connected to the integrated circuit 202b using the calibrated reference signals input respectively, and output the transmission signals to the transmission antennas 3b and 3d at the same time.

The transmission antennas 3a to 3d are spaced apart from each other by a distance 2D in the X-direction. The integrated circuit 202a connects the transmission antennas 3a and 3c, and the integrated circuit 202b connects the transmission antennas 3b and 3d. In such a case, at least a part of a calibration reception antenna 204 is disposed on a bisector 16 which is at an equal distance D from the transmission antennas 3a and 3b closest to the calibration reception antenna 204 among the transmission antennas 3a to 3d connected to the different integrated circuits 202a and 202b. In particular, the calibration reception antenna 4 includes a patch antenna 12a, a center or a gravity center position of which is located on the bisector 16 of a center line of the two transmission antennas 3a and 3b.

With the above configuration, the reception antenna 204 is disposed in a state to be theoretically identical in electric coupling amount among the transmission antennas 3a to 3d when receiving the transmission waves of the transmission antennas 3a to 3d. The reception antenna 204 according to the present embodiment is configured by connecting one patch antenna 12a to the reception circuit 5 through a microstripline 13. In this way, the reception antenna 204 may not be identical in shape with the transmission antennas 3a to 3d.

In this situation, it is desirable that the control circuit 6 outputs the transmission signals from all the transmission circuits 210aa, 210ab, 210ba, and 210bb to the transmission antennas 3a to 3d, and sets an adjustment phase of the phase adjustment circuits 211a and 211b so that the reception amplitude of the received signal of the reception circuit 5 in this situation becomes largest. It is desirable that the calibration phases φ of the phase adjustment circuits 211a and 211b are set to be the same value, but phases φ different from each other may be set.

In addition, the control circuit 6 may output the transmission signals to the transmission circuits 210aa and 210ab targeting the respective transmission antennas 3a and 3b closest to the reception antenna 204, and set the calibration phase of the phase adjustment circuit 211a so that the amplitude of the received signal from the reception circuit 5 in this situation becomes largest. In that case, the calibration phase φ adjusted by the phase adjustment circuit 211a may be set as the calibration phase φ of the phase adjustment circuit 211b, and the calibration phases φ of the two phase adjustment circuits 211a and 211b close to each other can be diverted as they are. In addition, the calibration process is performed in the same calibration procedure as that in the respective first, second, and third embodiments to obtain the same advantages as the in the respective embodiments.

### Fifth Embodiment

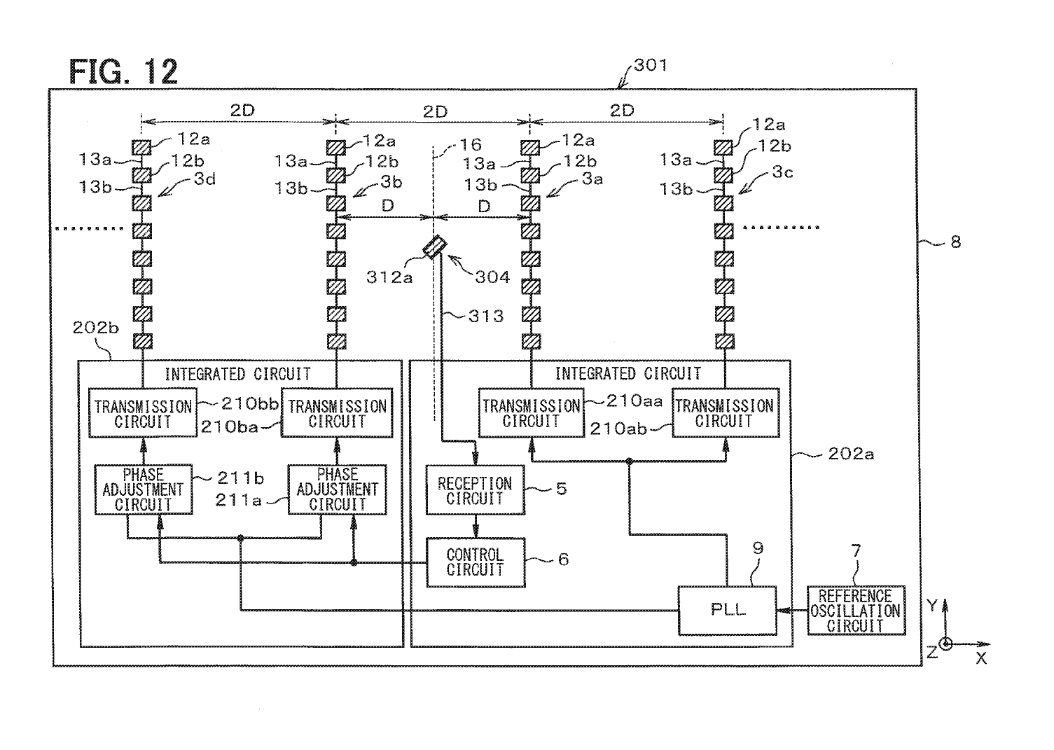

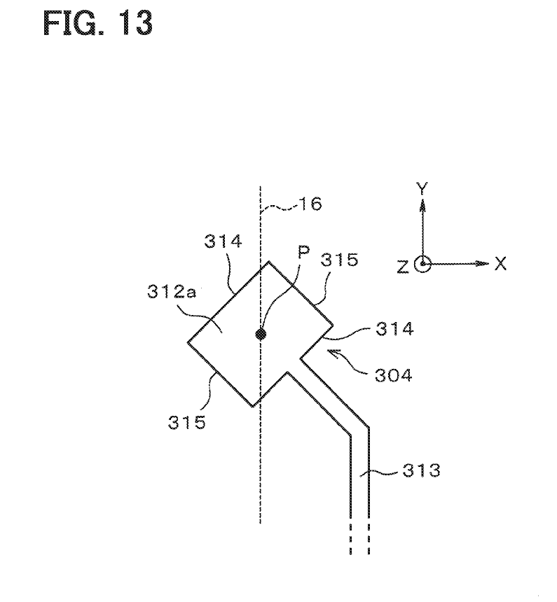

FIGS. 12 and 13 illustrate additional illustrative views of a fifth embodiment. The fifth embodiment illustrates another configuration of a reception antenna. The other configurations are identical with those of the above embodiments (for example, fourth embodiment), and therefore its description will be omitted.

As illustrated in FIG. 12, a reception antenna 304 includes a patch antenna 312a formed into a rectangular shape, and is connected to a reception circuit 5 through a microstripline 313. FIG. 13 is an enlarged top view of the reception antenna 304. The patch antenna 312a of the reception antenna 304 is disposed in such a manner that sides 314 of the rectangular shape are inclined by 45° from an X-direction and a Y-direction, and sides 315 are inclined from the X-direction and the Y-direction so as to be orthogonal to the sides 314. A bisector 16 between the transmission antennas 3a and 3b is disposed to pass through a center or the center of gravity P of the patch antenna 312a. As illustrated in FIG. 13, the reception antenna 304 is not disposed to be symmetric with respect to the bisector 16 in the X-direction. Even in such an arrangement, because the reception antenna 304 is disposed in a state to be theoretically identical in electric coupling amount between the transmission antennas 3a and 3b, the same advantages as the in the above embodiments are obtained.

Incidentally, in the arrangement position of the patch antenna 312a configuring the reception antenna 304 in the Y-direction, the patch antenna 312a according to the present embodiment is disposed in a facing area between the transmission antennas 3a and 3b as illustrated in FIG. 12. However, the arrangement position of the patch antenna 312a in the Y-direction is not limited to this position. As illustrated in a sixth or seventh embodiment to be described later, the patch antenna 312a may be disposed at a position departing from the facing area of the transmission antennas 3a and 3b. In short, the reception antenna 304 may be disposed in a state to be theoretically identical in electric coupling amount among the transmission antennas 3a, 3b . . . when receiving the transmission waves of the transmission antennas 3a, 3b . . . . In the present embodiment, the calibration process is performed in the same calibration procedure as that in the respective first, second, and third embodiments to obtain the same advantages as the in the respective embodiments.

### Sixth Embodiment

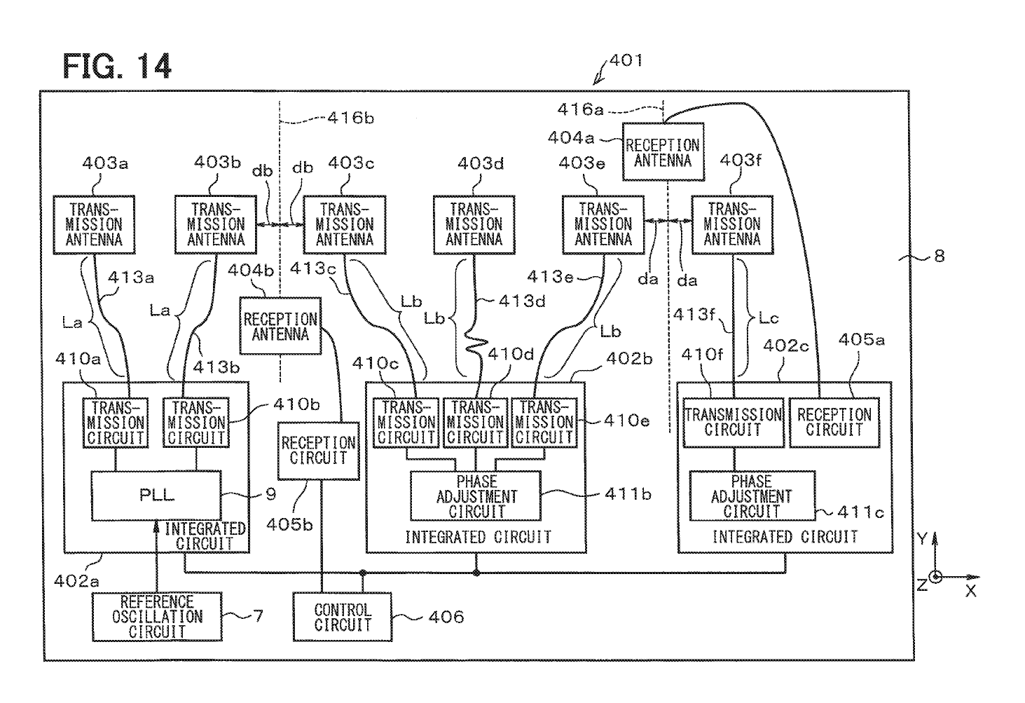

FIG. 14 illustrates an additional illustrative view of a sixth embodiment. The sixth embodiment illustrates another configuration of a millimeter wave radar system 401. FIG. 14 schematically illustrates a relationship of an arrangement of transmission antennas 403a to 403f, reception antennas 404a, 404b, integrated circuits 402a, 402b, 402c, reception circuits 405a, 405b, and a control circuit 406 mounted on the substrate 8.

The integrated circuit 402a includes a PLL circuit 9, and transmission circuits 410a, 410b. The integrated circuit 402b includes a phase adjustment circuit 411b and transmission circuits 410c, 410d, 410e. The integrated circuit 402c includes a phase adjustment circuit 411c, a transmission circuit 410f, and a reception circuit 405a. The configurations and the functions of the transmission circuits 410a to 410f and the phase adjustment circuits 411b, 411c are identical with those of the transmission circuits 10a, 10b, and the phase adjustment circuit 11 in the above-mentioned embodiments, respectively, and therefore their description will be omitted. Although not illustrated, the transmission antennas 403a to 403f are identical in the shape with each other.

The transmission antennas 403e and 403f are spaced apart from each other by a distance 2×da, and at least a part of the reception antenna 404a is formed on a bisector 411a between the transmission antennas 403e and 403f. Likewise, the transmission antennas 403b and 403c are spaced apart from each other by a distance 2×db, and at least a part of the reception antenna 404b is formed on a bisector 416b between the transmission antennas 403b and 403c.

As illustrated in FIG. 14, when the integrated circuits 402a, 402b, and 402c are mounted on the substrate 8, the number of transmission antennas 403a to 403f to which the transmission signals are to be output from the individual integrated circuits 402a, 402b, and 402c are not limited to same number, but may be different from each other. As illustrated in FIG. 14, the integrated circuit 402a outputs the transmission signals to the two transmission antennas 403a and 403b whereas the integrated circuit 402b outputs the transmission signals to the three transmission antennas 403c, 403d, and 403e, and the integrated circuit 402c outputs the transmission signal to one transmission antenna 403f.

In a configuration illustrated in FIG. 14, it is desirable that line lengths La of microstriplines 413a and 413b between one integrated circuit 402a and the two transmission antennas 403a and 403b connected to the integrated circuit 402a are set to be identical with each other. Likewise, it is desirable that line lengths Lb of microstriplines 413a to 413e between the integrated circuit 402b and the three transmission antennas 403c to 403e connected to the integrated circuit 402b are set to be identical with each other. In such a case, the phases of the transmission waves of the transmission antennas 403a and 403b connected to the integrated circuit 402a can be set to be identical with each other, and likewise the phases of the transmission waves of the transmission antennas 403c and 403e connected to the integrated circuit 402b can be set to be identical with each other. When it is assumed that a line length of a microstripline 413f between the integrated circuit 402c and the transmission antenna 403f is Lc, the line lengths La, Lb, and Lc may be identical with each other or different from each other.

In addition, when the calibration process described in the first to third embodiments are applied, even if the transmission waves are output from all of the transmission antennas 403a to 403f, the coupling amount to the reception antennas 404a and 404b may not be set to be equal to each other. This is because the respective transmission antennas 403a to 403f interfere with each other. When such a case is assumed, in order to set the coupling amount to the reception antennas 404a and 404b of the transmission antennas 403a to 403f to be equal to each other, it is desirable that the control circuit 406 allows the transmission waves to be output from the two adjacent transmission antennas (for example, 403b and 403c, 403e and 403f) closest to each other, performs the calibration process, and sets the calibration phases φ obtained by the calibration process as the calibration phases φ of the phase adjustment circuits 411b and 411c within the respective integrated circuits 402b and 402c.

A specific calibration procedure example will be described. First, the control circuit 406 allows the transmission wave to be output from the transmission antenna 403b closest to the bisector 416b in the two transmission antennas 403a and 403b connected to the integrated circuit 402a. Also, the control circuit 406 allows the transmission wave to be transmitted from the transmission antenna 403c closest to the bisector 416b in the three transmission antennas 403c to 403e connected to the integrated circuit 402b. As illustrated in the first to third embodiments, the control circuit 406 performs the calibration process for the phase φ of the phase adjustment circuit 411b, and uses the phase φ calculated through the calibration process as a calibration phase φ1 of the phase adjustment circuit 411b.

After the calibration phase φ1 of the phase adjustment circuit 411b has been set, the control circuit 406 allows the transmission wave to be output from the transmission antenna 403b closest to the bisector 411a in the three transmission antennas 403a and 403e connected to the integrated circuit 402b. Also, the control circuit 406 allows the transmission wave to be transmitted from one transmission antenna 403f closest to the bisector 411a connected to the integrated circuit 402c. As illustrated in the first to third embodiments, the control circuit 406 performs the calibration process for the phase φ of the phase adjustment circuit 411c, and uses the calibration phase φ calculated through the calibration process as a calibration phase φ2 of the phase adjustment circuit 411c. Even if three or more of the integrated circuits 402a to 402c are disposed, the calibration phases φ1 and φ2 of the phase adjustment circuits 411b and 411c incorporated into the integrated circuits 402b and 402c can be sequentially calculated. Therefore, as in the first to third embodiments, the phase satisfying the condition in which the reception amplitude becomes maximum is set as the calibration phase φ, to thereby obtain the same advantages as the illustrated in the first to third embodiments.

In addition, as illustrated in FIG. 14, the reception antenna 404a may be disposed in an area departing from the facing area of the transmission antennas 403e and 403f in the Y-direction, and the reception antenna 404b may be disposed in an area departing from the facing area of the transmission antennas 403b and 403c in the Y-direction. For example, dimensions of the patch antennas 12a and 12b illustrated in FIG. 1 in the X- and Y-directions are rectangular in about a few mm×a few mm, and the dimensions of the patch antennas 12a and 12b are increased to obtain an antenna gain. However, because a distance 2D between the transmission antennas 3a and 3b is also a few mm, and set in the same digit scale as that of the dimensions of the patch antennas 12a and 12b in the X- and Y-directions, the patch antennas 12a and 12b come close to the reception antenna 4.

As described above, when the an arrangement space, for example, in the X-direction is limited, as illustrated in FIG. 14, the reception antennas 404a and 404b may depart from the facing area of the transmission antennas 3a and 3b in the Y-direction, and in that case, the arrangement space can be effectively used.

The reception antenna 404a may be disposed at any position if at least a part of the reception antenna 404a is disposed on the bisector 411a between the transmission antennas 403e and 403f. The reception antenna 404b may be disposed at any position if at least a part of the reception antenna 404b is disposed on the bisector 416b between the transmission antennas 403b and 403c. In addition, the shapes of the reception antennas 404a and 404b may be different from the shapes of the transmission antennas 403a to 403f. Incidentally, specific configuration examples of the reception antennas 404a and 404b will be descried in an embodiment to be described later.

### Seventh Embodiment

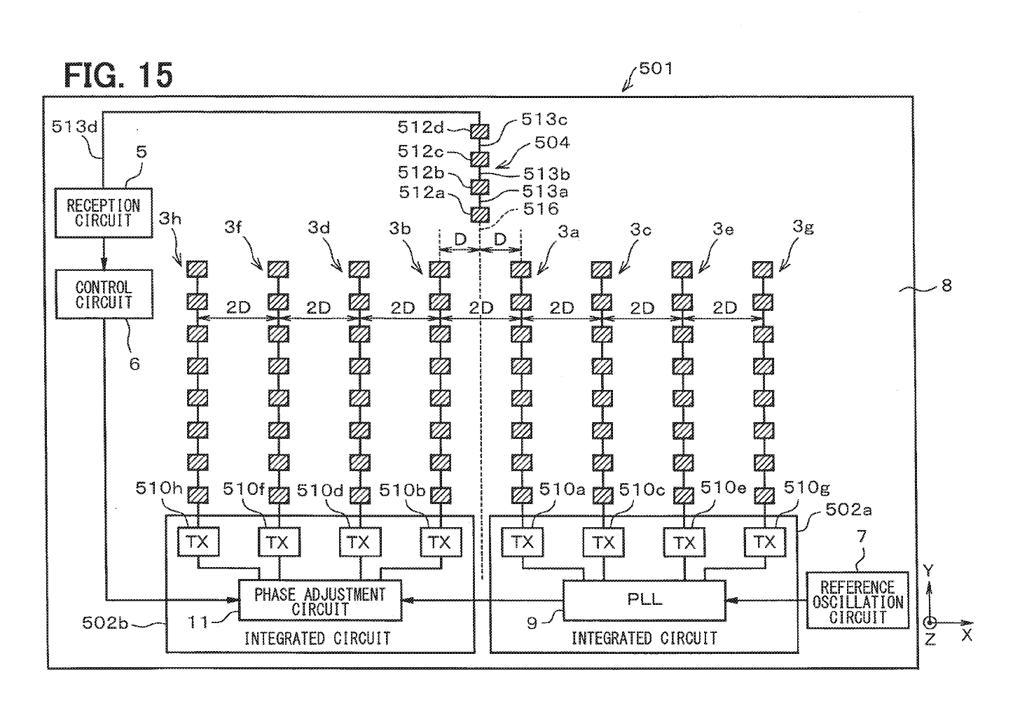

FIG. 15 illustrates an additional illustrative view of a seventh embodiment. FIG. 15 schematically illustrates an installation example and a configuration example of transmission antennas and a reception antenna schematically shown in the sixth embodiment.

As illustrated in FIG. 15, a millimeter wave radar system 501 includes a control circuit 6, a reception circuit 5, a reference oscillation circuit 7, two integrated circuits 502a, 502b, transmission antennas 3a to 3g, and a reception antenna 504, which are mounted on a substrate 8. The integrated circuit 502a is connected with transmission antennas 3a, 3c, 3e, and 3g, and the integrated circuit 502b is connected with transmission antennas 3b, 3d, 3f, and 3h. The integrated circuit 502a includes a PLL circuit 9 and transmission circuits 510a, 510c, 510e, and 510g, and the integrated circuit 502b includes a phase adjustment circuit 11 and transmission circuits 510b, 510d, 510f, and 510h. The transmission circuits 510a to 510h are identical in the configuration with the transmission circuits 10a, 10b . . . . The configurations of the transmission antennas 3a to 3h are identical with each other, the arrangement position and the arrangement relationship of the transmission antennas are identical with those of the transmission antennas 3a, 3b . . . described in the first embodiment, and therefore their description will be omitted.

A part of the calibration reception antenna 504 is placed on a bisector 516 between the transmission antennas 3a and 3b closest to each other among the transmission antennas 3a to 3h connected to the two integrated circuits 502a and 502b. The calibration reception antenna 504 is not present in a facing area between the two target transmission antennas 3a and 3b in the X-direction, but departs from the facing area in the Y-direction.

The reception antenna 504 is configured by connecting rectangular patch antennas 512a to 512d through microstriplines 513a to 513c. Each of the patch antennas 512a to 512d is disposed so that one sides of the rectangular shape extend in the X-direction, and the other sides extend in the Y-direction. The microstriplines 513a to 513c coupling the patch antennas 512a to 512d together are disposed, for example, in such a manner that the centers of the lines match the bisector 516 between the transmission antennas 3a and 3b. The patch antennas 512a to 512d are disposed so that the positions of the center and the center of gravity of the patch antennas 512a to 512d match the bisector 516. The microstripline 513d is formed between the patch antenna 512d and the reception circuit 5.

In the present embodiment, the patch antennas 512a to 512d of the reception antenna 504 are disposed to be symmetric with respect to the bisector 516 as a center line in the X-direction. Thus, the calibration reception antenna 504 is disposed in a state to be theoretically identical in electric coupling amount between the transmission antennas 3a to 3h when receiving the transmission waves of the transmission antennas 3a to 3h. Therefore, as described in the first to third embodiments, the phase satisfying the condition in which the reception amplitude becomes maximum is set as the calibration phase φ of the phase adjustment circuit 11, to thereby obtain the same advantages as the illustrated in the first to third embodiments.

### Eighth Embodiment

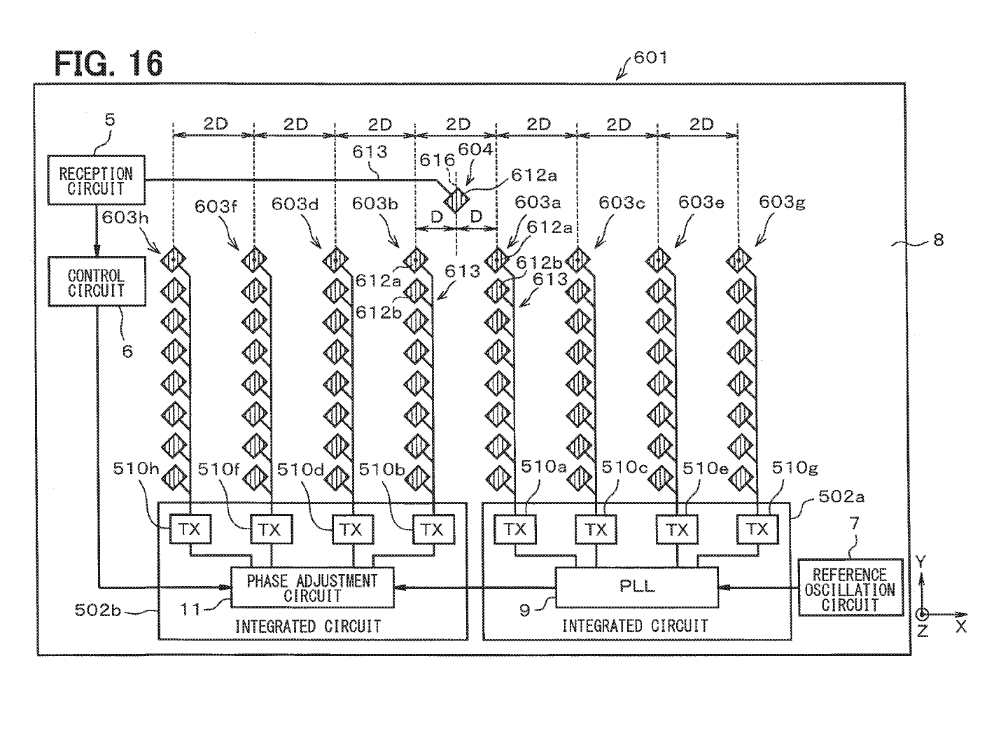

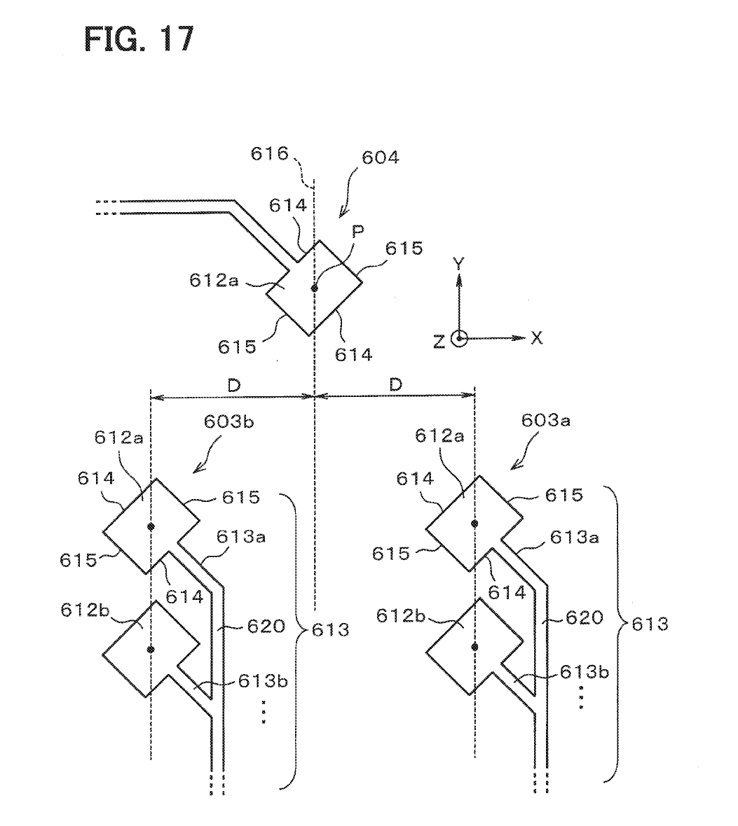

FIGS. 16 and 17 illustrate additional illustrative views of an eighth embodiment. FIG. 16 schematically illustrates another installation example and another configuration example of transmission antennas and a reception antenna schematically shown in the sixth embodiment.

As illustrated in FIG. 16, a millimeter wave radar system 601 includes a control circuit 6, a reception circuit 5, a reference oscillation circuit 7, two integrated circuits 502a, 502b, transmission antennas 603a to 603h, and a reception antenna 604, which are mounted on a substrate 8. The transmission circuits 510a, 510c, 510e, and 510g of the integrated circuit 502a are connected with transmission antennas 603a, 603c, 603e, and 603g, respectively. The transmission circuits 510b, 510d, 510f, and 510h of the integrated circuit 502b are connected with transmission antennas 603b, 603d, 603f, and 603f, respectively. All of the transmission antennas 603a to 603h are identical in the configuration with each other, but are different in planar structure from the transmission antennas 3a to 3h illustrated in the above-mentioned embodiment. The transmission antennas 603a to 603h are configured in such a manner that patch antennas 612a, 612b . . . are coupled with each other through a microstripline 613.

FIG. 17 schematically illustrates a part of the transmission antennas 603a, 603b, and the reception antenna 604. As illustrated in FIG. 17, the patch antenna 612a has a rectangular metal surface on a surface of the substrate 8. One sides 614 of the metal surface are inclined by, for example, 45° with respect to the X-direction and the Y-direction, and the other sides 615 are also inclined with respect to the X-direction and the Y-direction, and orthogonal to one sides 614.

Incidentally, as illustrated in FIGS. 16 and 17, the patch antennas 612b . . . are also identical in the structure with the patch antenna 612a. The transmission antennas 603a to 603h are configured in such a manner that the centers of one sides 614 of the metal surfaces of the patch antennas 612a, 612b . . . are coupled with each other through the microstripline 613.

As illustrated in FIG. 17, the microstripline 613 includes a baseline portion 620 that extends from feeding points of the integrated circuits 502a and 502b in the Y-direction, and branch portions 613a, 613b . . . that extend from halfway portions of the baseline portion 620 in a predetermined direction that is oblique to the X- and Y-directions and are connected to center portions of the sides 614 of the respective patch antennas 612a, 612b . . . . The branch portions 613a, 613b . . . of the microstripline 613 are connected orthogonally to the sides 614 of the respective patch antennas 612a, 612b . . . . The transmission antennas 603a to 603h are aligned in the X-direction. With the above configuration, for example, as compared with the configuration of the transmission antennas 3a, 3b . . . according to the first embodiment, the transmission antennas 603a to 603h can change polarization directions.

When a bisector 616 is drawn between the transmission antennas 603a and 603b closest to each other among the transmission antennas 603a to 603h connected to the integrated circuits 502a and 502b along the Y-direction, distances from the centers of the patch antennas 612a and 612b of the target transmission antennas 603a and 603b to the bisector 616 are D.

At least a part of the calibration reception antenna 604 is disposed on an extension line of the bisector 616 in the Y-direction. The calibration reception antenna 604 is not present in a facing area between the two target transmission antennas 603a and 603b in the X-direction, but departs from the facing area in the Y-direction. The calibration reception antenna 604 is configured by connecting the rectangular patch antennas 612a to the reception circuit 5 through the microstripline 613.

In the present embodiment, the patch antenna 612a of the reception antenna 604 is arranged and structured as in the patch antenna 312a of the fifth embodiment. In other words, the patch antenna 612a of the reception antenna 604 is formed into a rectangular shape, and the sides 614 of the rectangular shape are inclined from an X-direction and a Y-direction, and sides 315 are inclined from the X-direction and the Y-direction so as to be orthogonal to the sides 314.

As illustrated in FIG. 17, the bisector 616 of the patch antennas 612a, 612b . . . of the transmission antennas 603a and 603b is disposed to pass through a center and the center of gravity P of the patch antenna 612a of the reception antenna 604. In that case, the patch antenna 612a of the reception antenna 604 is not disposed to be symmetric with respect to the bisector 616 as a center line. Similarly, in such a configuration, the calibration reception antenna 604 is disposed in a state to be theoretically identical in electric coupling amount between the transmission antennas 603a, 603b . . . when receiving the transmission waves of the transmission antennas 603, 60b . . . . Therefore, as described in the first to third embodiments, the phase φ satisfying the condition in which the reception amplitude becomes maximum is calibrated as the calibration phase, to thereby obtain the same advantages as the illustrated in the first to third embodiments.

### Ninth Embodiment

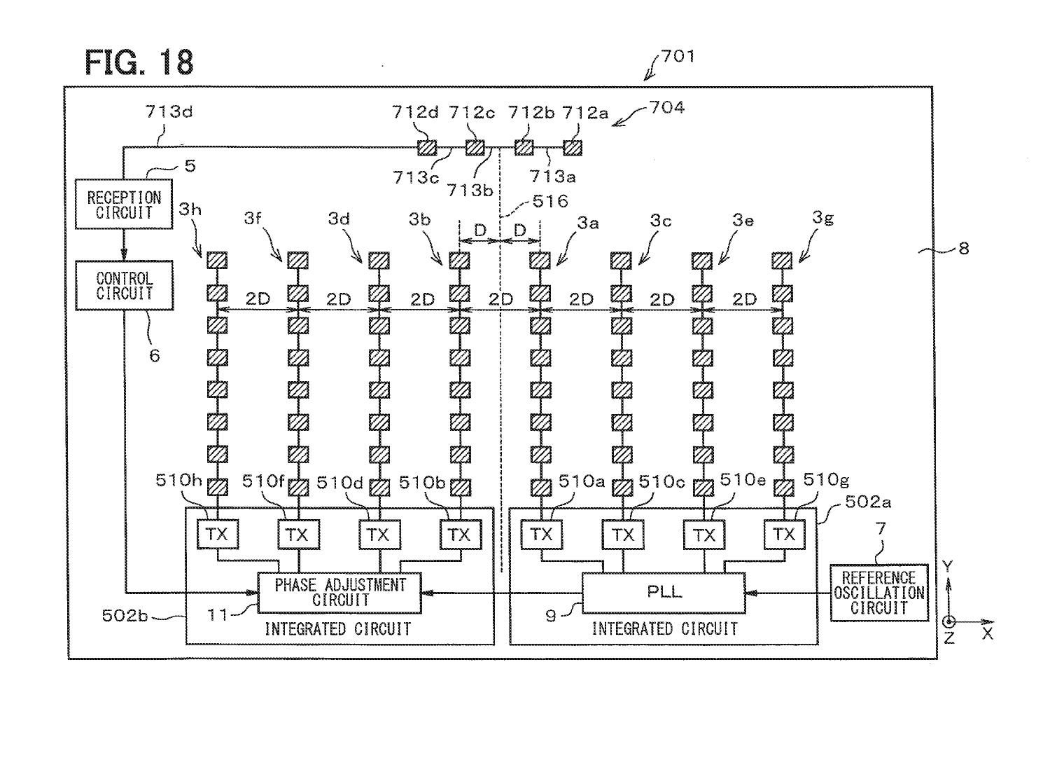

FIG. 18 illustrates an additional illustrative view of a ninth embodiment. FIG. 18 schematically illustrates another installation example and another configuration example of transmission antennas and a reception antenna schematically shown in the sixth embodiment.

As illustrated in FIG. 18, a millimeter wave radar system 701 includes a reception circuit 5, a control circuit 6, a reference oscillation circuit 7, two integrated circuits 502a, 502b, transmission antennas 503a to 503h, and a reception antenna 704, which are mounted on a substrate 8. The other configurations other than the reception antenna 704 are identical with the configurations illustrated in the seventh embodiment, and therefore its description will be omitted.

A part of the reception antenna 704 is placed on a bisector 516 between the transmission antennas 3a and 3b closest to each other in correspondence with the two integrated circuits 502a and 502b among the transmission antennas 3a to 3h connected to the two integrated circuits 502a and 502b. The calibration reception antenna 704 is not present in a facing area between the two target transmission antennas 3a and 3b in the X-direction, but departs from the facing area in the Y-direction.

The reception antenna 704 includes rectangular patch antennas 712a to 712d and microstriplines 713a to 713c, and the reception antenna 704 is configured by coupling the patch antennas 712a to 712d together through the microstriplines 713a to 713c.

Each of the patch antennas 712a to 712d is disposed so that one sides of the rectangular shape extend in the X-direction, and the other sides extend in the Y-direction. The patch antennas 712a to 712d and the microstriplines 713a to 713c are disposed across the bisector 516 between the transmission antennas 3a and 3b.

The patch antennas 712a and 712b are disposed on one side (right side in the drawing) of the bisector 516 in the X-direction, and the patch antennas 712c and 712 are disposed on the other side (left side in the drawing) of the bisector 516 in the X-direction. The patch antennas 712a, 712b, 712c, and 712d are disposed to be symmetric with respect to the bisector 516 as a center line. The microstripline 713d is formed between the patch antenna 712d and the reception circuit 5.

In the present embodiment, the patch antennas 712a to 712d of the reception antenna 704 are disposed to be symmetric with respect to the bisector 516 as a center line in the X-direction. Thus, the calibration reception antenna 704 is disposed in a state to be theoretically identical in electric coupling amount between the transmission antennas 3a to 3h when receiving the transmission waves of the transmission antennas 3a to 3h. Therefore, as described in the first to third embodiments, the phase satisfying the condition in which the reception amplitude becomes maximum is set as the calibration phase φ of the phase adjustment circuit 11, to thereby obtain the same advantages as the illustrated in the first to third embodiments.

### OTHER EMBODIMENTS

The present invention is not limited to the embodiments described above, but can be implemented with various modifications, and can be applied to various embodiments without departing from the spirit of the present disclosure. For example, the modifications or expansions described below are enabled.

In the above embodiment, the oscillation signal of the reference oscillation circuit 7 is multiplied using the PLL circuit 9 shown in FIG. 1. The PLL circuit 9 can be configured using, for example, a voltage-controlled oscillator (VCO), and also may be configured by a VCO.

In all of the above-mentioned configurations (for example, first to ninth embodiments), the patch antenna configuring one transmission antenna is aligned along the Y-direction. For example, in the first embodiment, the patch antennas 12a and 12b . . . configuring the transmission antenna 3a is aligned in the Y-direction. The present embodiment is not limited to the above configuration, but, for example, the patch antennas 12a, 12b . . . may be disposed on a curved surface or may be disposed at random.

In that case, for example, if the patch antennas 12a, 12b . . . or 612a, 612b . . . are disposed symmetrically with respect to the bisectors 16, 516, and 616, an arrangement relationship between the transmission antennas 3a, 3b . . . or 603a, 603b . . . and the reception antennas 4, 504, 604, or 704, can be put into a state to be theoretically identical in electric coupling amount between the transmission antennas and the reception antenna. Therefore, the transmission antennas 3a, 3b . . . may align the patch antennas 12a, 12b . . . in any direction, and the reception antenna 4 may have any arrangement relationship with the patch antennas 12a, 12b . . . of the transmission antennas 3a, 3b . . . . In short, the reception antenna 304 may be disposed in a state to be theoretically identical in electric coupling amount with respect to the transmission antennas 3a and 3b.

In FIGS. 1, 16, and so on, the patch antennas 12a, 12b . . . or 612a, 612b configuring the transmission antennas 3a, 3b . . . or 603a and 603b, and the patch antennas 12a, 12b . . . or 612a configuring the reception antenna 4 or 604 are denoted by the same reference numerals or symbols. The same reference numerals or symbols show that the characteristics as the patch antennas are the same, and it should be noted that the components are not a single body but separate bodies.

In the above-mentioned embodiments, for example, the first embodiment, the integrated circuits 2b . . . that perform the slave operation include the phase adjustment circuit 11, but the integrated circuit 2a that performs the master operation has no phase adjustment circuit 11. Alternatively, the integrated circuit 2a may also include the phase adjustment circuit 11. In other words, for example, in the first embodiment, all of the integrated circuits 2a, 2b . . . may include the phase adjustment circuit 11.

For example, the calibration process of the above-mentioned embodiments may be performed at a timing of changing a frequency multiplied by the PLL circuit 9 of each integrated circuit. Also, for example, a temperature sensor may be provided, separately, and the calibration process of the above-mentioned embodiments may be performed when the temperature changes by a predetermined value or more.

For example, functions of a single component may be distributed to components, or functions of components may be integrated in a single component. In addition, at least a part of the above-described embodiments may be switched to a known configuration having the same functions. In addition, a part or all of the configurations of the two or more embodiments described above may be combined together, or replaced with each other. Symbols in parenthesis described in the claims represent a correspondence relationship with specific means described in embodiments described above as one aspect of the present disclosure, but do not restrict the technical scope of the present disclosure.

What is claimed is:

1. A phase calibration device comprising:
a plurality of transmission antennas disposed to enable directions of transmission waves to be changed using a beam forming technology, the plurality of transmission antennas including a first transmission antenna and a second transmission antenna that is different from the first transmission antenna;
a first integrated circuit outputting a transmission signal for generating the transmission wave of the first transmission antenna using a reference signal upon receiving the reference signal;
a second integrated circuit connected to the first integrated circuit, receiving a reference signal from the first integrated circuit, and outputting a transmission signal for generating the transmission wave of the second transmission antenna;
a calibration reception antenna disposed in a state to be theoretically identical in electric coupling amount when receiving the transmission waves of the first transmission antenna and the second transmission antenna;
a reception circuit acquiring a received signal from the calibration reception antenna; and
a control circuit calibrating phases of the transmission signals based on an amplitude of the received signal of the reception circuit which is changed in response to a change in a phase difference between the transmission signals when the first integrated circuit and the second integrated circuit output the transmission signals to the first transmission antenna and the second transmission antenna.

2. The phase calibration device according to claim 1, wherein
the calibration reception antenna is disposed at an equal distance from the first transmission antenna and the second transmission antenna.

3. The phase calibration device according to claim 1, wherein
the calibration reception antenna is disposed in an area outside a facing area between the first transmission antenna and the second transmission antenna.

4. The phase calibration device according to claim 1, wherein
the calibration reception antenna is disposed in the facing area of the plurality of transmission antennas.

5. The phase calibration device according to claim 1, wherein
each of the plurality of transmission antennas is configured by connecting one or a plurality of patch antennas by a microstripline.

6. The phase calibration device according to claim 1, wherein
the control circuit changes the phase difference of the transmission signals output from the first integrated circuit and the second integrated circuit for each predetermined step to allow the transmission waves to be output from the first transmission antenna and the second transmission antenna, detects a phase at which the amplitude of the received signal of the reception circuit becomes maximum, and sets a calibration phase using the detected phase.

7. The phase calibration device according to claim 6, wherein
the control circuit detects the phase at which the amplitude of the received signal of the reception circuit becomes maximum when changing the phase difference in a range from an initial value to 360° added to the initial value, and sets a calibration phase using the detected phase.

8. The phase calibration device according to claim 6, wherein
the control circuit detects a phase at which the amplitude of the received signal of the reception circuit becomes a maximum value or minimum value when changing the phase difference in a range from an initial value to 180° added to the initial value, sets a calibration phase using a phase satisfying a maximum value condition when the phase satisfying the maximum value condition is detected, and sets a calibration phase using a phase obtained by adding 180° to a phase satisfying a minimum value condition when the phase satisfying the minimum value condition is detected.

9. The phase calibration device according to claim 6, wherein
the control circuit detects a phase at which the amplitude of the received signal of the reception circuit becomes a maximum value or a minimum value when changing the phase difference of the transmission signals output from the first integrated circuit and the second integrated circuit from an initial value for each predetermined step, sets a calibration phase using a phase satisfying a maximum value condition when the phase satisfying the maximum value condition is detected, and sets a calibration phase using a phase obtained by adding 180° to a phase satisfying a minimum value condition when the phase satisfying the minimum value condition is detected.

10. The phase calibration device according to claim 1, wherein
each of the first integrated circuit and the second integrated circuit outputs the transmission signal modified through an FMCW system.

11. The phase calibration device according to claim 1, wherein
the calibration reception antenna also works as a target detection antenna.
